(19) United States
(12) Patent Application Publication
(10) Pub. No.: US 2011/0118936 A1
(43) Pub. Date: May 19, 2011

(54) LANE-KEEPING CONTROL METHOD AND SYSTEM

(75) Inventor: Dae Gun HONG, Seoul (KR)

(73) Assignee: MANDO CORPORATION

(21) Appl. No.: 12/939,833

(22) Filed: Nov. 4, 2010

(30) Foreign Application Priority Data
Nov. 17, 2009 (KR) 10-2009-0110687

(51) Int. Cl. B62D 6/08; G08G 1/16

(52) U.S. Cl. 701/41

(57) ABSTRACT

Disclosed are a lane-keeping control system and method. The lane-keeping control system includes: an information acquiring device for acquiring lane information for a neighboring lane, and neighboring vehicle information for a neighboring vehicle in a lane neighboring with a lane in which a lane-keeping controlled vehicle is running; an electronic control device for setting a running track of the lane-keeping controlled vehicle in the lane-keeping controlled vehicle's lane on the basis of the acquired lane information and the neighboring vehicle information, the electronic device producing steering torque maps along the running track, and calculating steering overlay torque values from the produced steering torque maps; and a steering device for performing steering torque control in accordance with the steering overlay torque values calculated by the electronic control device.

### CROSS-REFERENCE TO RELATED APPLICATION

This application claims priority from and the benefit of Korean Patent Application No. 10-2009-0110687, filed on Nov. 17, 2009, which is hereby incorporated by reference for all purposes as if fully set forth herein.

### BACKGROUND OF THE INVENTION

1. Field of the Invention

The present invention relates to a lane-keeping control method and system, and more particularly to a lane-keeping control method and system for assisting a driver to be capable of driving a vehicle safely without causing the vehicle to be moved out of its lane by controlling lane-keeping in consideration of a neighboring vehicle as well as a neighboring lane.

2. Description of the Prior Art

In the past, LKA (Lane-Keeping Assist) systems were developed for controlling steering in such a manner that a vehicle (“lane-keeping controlled vehicle”) cannot be moved out of its lane by sensing the lane through a front camera and calculating the position of the lane-keeping controlled vehicle in relation to the lane.

Since such a conventional lane-keeping assist system senses a neighboring (front) lane for the lane-keeping controlled vehicle, and controls the lane-keeping of the lane-keeping controlled vehicle, only using lane information for the sensed lane so that it cannot be moved out of its lane, such a lane-keeping assist system has a problem in that it cannot perform lane-keeping in consideration of a neighboring vehicle traffic situation. For example, when another vehicle running in a neighboring lane is moving ahead of the lane-keeping controlled vehicle, the lane-keeping controlled vehicle may collide with the vehicle running ahead, or may be moved out of its lane so as to avoid the vehicle running ahead, which may cause a traffic accident or personal damage.

### SUMMARY OF THE INVENTION

Accordingly, the present invention has been made to solve the above-mentioned problems occurring in the prior art, and an object of the present invention is to assist a driver to be capable of driving a vehicle safely without causing the vehicle to be moved out of its lane by controlling the lane-keeping of the vehicle in consideration of a neighboring traffic situation as well as a neighboring lane.

In order to accomplish this object, there is provided a lane-keeping control system including: an information acquiring device for acquiring lane information for a neighboring lane, and neighboring vehicle information for a neighboring vehicle in a lane neighboring with a lane in which a lane-keeping controlled vehicle is running; an electronic control device for setting a running track of the lane-keeping controlled vehicle in the lane-keeping controlled vehicle's lane on the basis of the acquired lane information and the neighboring vehicle information, the electronic device producing steering torque maps along the running track, and calculating a steering overlay torque value from the produced steering torque maps; and a steering device for performing steering torque control in accordance with the steering overlay torque values calculated by the electronic control device.

In accordance with another aspect of the present invention, there is provided a lane-keeping control method including the steps of: sensing a neighboring vehicle positioned within a predetermined boundary on the basis of lane information, and neighboring vehicle information for a neighboring vehicle in a lane neighboring with a lane in which a lane-keeping controlled vehicle is running; setting a running track of the lane-keeping controlled vehicle to be deviated from the center of the lane-keeping controlled vehicle's lane in the direction opposite to the neighboring vehicle within the lane-keeping controlled vehicle's lane when the neighboring vehicle is sensed in the predetermined boundary, and producing steering torque maps to be deviated along the deviatedly set running track; controlling steering force offset oriented to the lane-keeping controlled vehicle's lane on the basis of the deviatedly produced steering torque maps; and returning the deviatedly set running track and the deviatedly produced steering torque maps to the original states thereof, respectively, when no neighboring vehicle is sensed within the predetermined boundary or the sensed neighboring vehicle is out of the predetermined boundary, and controlling the steering force offset on the basis of the returned steering torque maps.

According to the present invention described above, a driver can be assisted to drive a vehicle safely without causing the vehicle to be moved out of its lane by controlling the lane-keeping of the vehicle in consideration of a neighboring vehicle traffic situation as well as the situation of a neighboring lane.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a lane-keeping control system in accordance with an embodiment of the present invention;

FIGS. 2a and 2b comparably show running tracks and steering torque maps set in a conventional lane-keeping control system and a conventional lane-keeping control system in accordance with an embodiment of the present invention so as to control lane-keeping, respectively;

FIG. 3 exemplifies steering torque control performed in accordance with a steering overlay torque value obtained from a running track and steering torque maps set in a lane-keeping control system in accordance with an embodiment of the present invention; and

FIG. 4 is a flowchart of a lane-keeping control method in accordance with another embodiment of the present invention.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

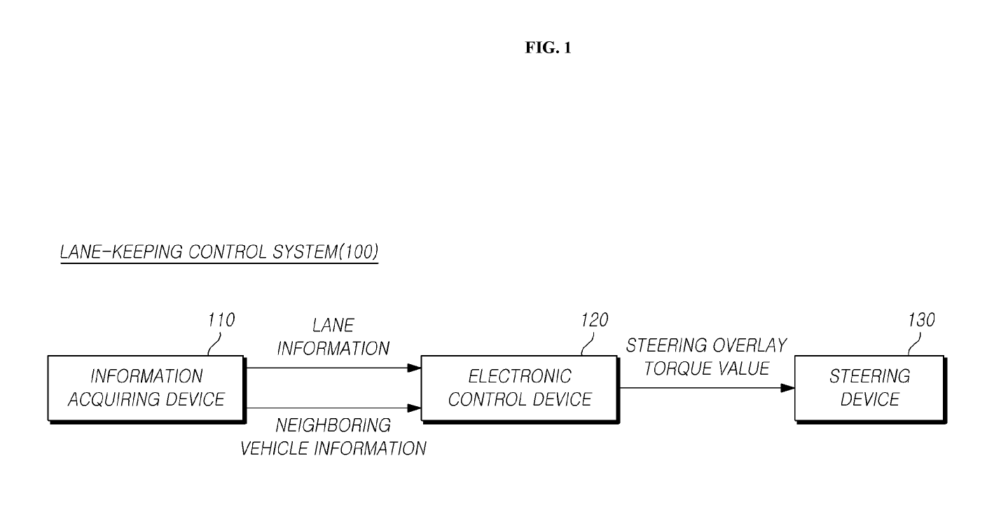

FIG. 1 is a block diagram of a lane-keeping control system in accordance with an embodiment of the present invention.

Referring to FIG. 1, the lane-keeping control system 100 in accordance with an embodiment of the present invention 100 includes: an information acquiring device 110 for acquiring neighboring lane information for a lane neighboring with a lane in which a lane-keeping controlled vehicle is running, and neighboring vehicle information for a neighboring vehicle in the lane neighboring with the lane-keeping controlled vehicle's lane; an electronic control device 120 for setting a running track of the lane-keeping controlled vehicle in the lane-keeping controlled vehicle's lane on the basis of the acquired lane information and the neighboring vehicle information, the electronic device 120 producing steering torque maps along the set running track, and calculating a required steering overlay torque value from the produced steering torque maps; and a steering device 130 for performing steering torque control in accordance with the steering overlay torque values calculated by the electronic control device 120.

The information acquiring device 110 senses a lane and a neighboring vehicle through an image of a neighboring area acquired through a camera, acquires “lane information” which includes at least one of a lateral offset between the lane-keeping controlled vehicle and a sensed lane, a heading angle of the lane-keeping controlled vehicle, and a road's curvature, on the basis of the sensed lane, and acquires “neighboring vehicle information” which includes at least one of a distance between the sensed neighboring vehicle and the lane-keeping controlled vehicle, the transverse position of the sensed neighboring vehicle, and the speed of the sensed neighboring vehicle, on the basis of the sensed neighboring vehicle.

On the basis of the lane information and the neighboring vehicle information acquired by the information acquiring device 120, if it is determined that the neighboring vehicle exists in a left or right lane neighboring with the lane-keeping controlled vehicle's lane, the electronic control device 120 sets the running track of the lane-keeping controlled vehicle to be deviated from the center of the lane-keeping controlled vehicle's lane in the direction opposite to the neighboring vehicle, and sets the steering torque maps to be also deviated along the deviatedly set running track.

When setting the lane-keeping controlled vehicle's running track to be deviated from the center of the lane-keeping controlled vehicle's lane in the direction opposite to the neighboring vehicle, the electronic control device 120 may determine the extent for deviating the running track of the lane-keeping controlled vehicle on the basis of the transverse position of the neighboring vehicle included in the neighboring vehicle information.

The steering device 130 is capable of performing steering torque control by adding the “steering overlay torque values” (“steering assist torque”) calculated by the electronic control device 120 to at least one of a “steering torque value exerted by a driver” and a “steering torque value by the steering device 130.”

The above-mentioned lane-keeping control system 100 in accordance with an embodiment of the present invention may be referred to as “LKA (Lane-Keeping Assist) system.”

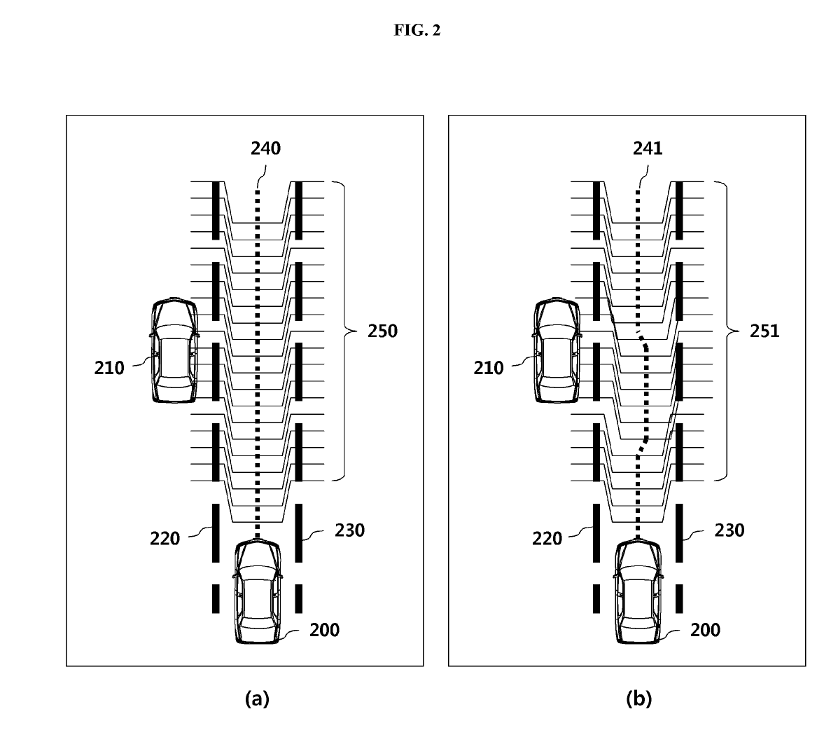

As described above, the inventive lane-keeping control system 100 controls lane-keeping, using “neighboring vehicle information” for a vehicle neighboring with the lane-keeping controlled vehicle as well as “lane information” for a lane neighboring with the lane-keeping controlled vehicle's lane, unlike a conventional lane-keeping control system for controlling lane-keeping on the basis of “the lane information” for the neighboring lane. Hereinafter, running tracks and steering torque maps set in a conventional lane-keeping control system and a conventional lane-keeping control system in accordance with an embodiment of the present invention so as to control lane-keeping will be described in comparison with reference to FIGS. 2a and 2b.

In FIGS. 2a and 2b, it is assumed that a neighboring vehicle 210 is running in a left lane separated by left lane marks 220 at the left of the lane-keeping controlled vehicle 200 which is performing the lane-keeping control function, and no vehicle is running in a right lane separated by right lane marks 220 at the right of the lane-keeping controlled vehicle 200.

Referring to FIG. 2a, a conventional lane-keeping control system for performing lane-keeping control through steering assist only in consideration of lane information controls lane-keeping using only the lane information for the left lane separated by the left lane marks 220 and the right lane separated by the right lane marks 230 without using the neighboring vehicle information for the neighboring vehicle 210. Here, since the conventional lane-keeping control system uses only the lane information so as to control the lane-keeping, i.e. so as to allow the lane-keeping controlled vehicle 200 to run in its lane without being moved out of its lane, the conventional lane-keeping control system sets a running track 240 as shown in FIG. 2a, and steering torque maps 250 are also set according to the running track 240 as shown in FIG. 2a. Therefore, when passing by the neighboring vehicle 210, problems in safe driving may be caused in that due to the approaching of the neighboring vehicle 210, the lane-keeping controlled vehicle 200 may collide with the neighboring vehicle 210 or may be moved out of its lane. The steering torque maps 250 are graphs which show the variation of torque about the running track 240 in the shape of a bath tub. FIG. 2a shows a plurality of steering torque maps 250 continuously for plural positions of the running track.

In other words, since the conventional lane-keeping control system senses a neighboring lane neighboring with the lane-keeping controlled vehicle and controls lane-keeping to prevent the lane-keeping controlled vehicle 200 from being moved out of its lane, using only the lane information for the sensed lane, there is a problem in that it is impossible to control lane-keeping to prevent the lane-keeping controlled vehicle from being moved out of its lane in consideration of the vehicle traffic situation around the lane-keeping controlled vehicle 200. For example, if another neighboring vehicle 210 running in a neighboring lane exists ahead of the lane-keeping controlled vehicle 200, problems may be caused in that the lane-keeping controlled vehicle 200 may collide with the neighboring vehicle 210 or may be moved out of its lane so as to avoid the neighboring vehicle 210.

Referring to FIG. 2b, since the inventive lane-keeping control system 100 performs lane-keeping control through steering assist which is made in consideration of both of the lane information concerning the left lane separated by left lane marks 220 and the right lane separated by right lane marks 230, and the neighboring vehicle information concerning a neighboring vehicle 210, the inventive lane-keeping control system 100 sets the running track 241 to be deviated in the direction opposite to the neighboring vehicle in the area adjacent to the neighboring vehicle as shown in FIG. 2c. The steering torque maps 251 are also produced to be deviated from the center of the lane-keeping controlled vehicle's lane in the area adjacent to the neighboring vehicle along the deviatedly set running track 241. Therefore, even if the lane-keeping controlled vehicle 200 passes by the neighboring vehicle, it can safely run by the side of the neighboring vehicle 210 in accordance with the steering assist torque (i.e., steering overlay torque values) according to the steering torque maps 251 produced to be deviated from the center of the lane-keeping controlled vehicle's lane. The steering torque maps 250 are graphs which show the variation of torque about the running track 240 in the shape of a bath tub. FIG. 2a shows a plurality of steering torque maps continuously for plural positions of the running track.

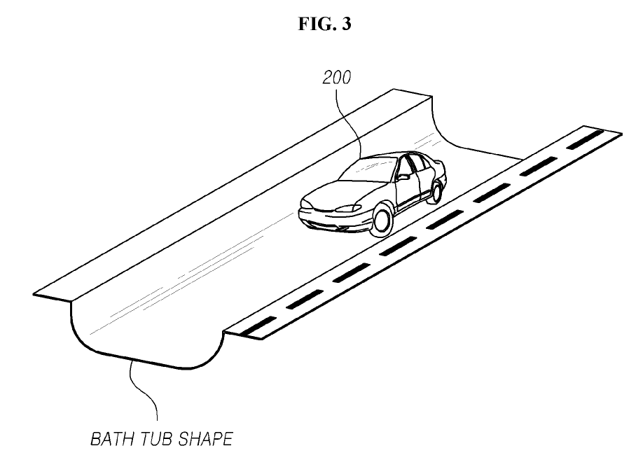

As shown in FIG. 2b, the inventive lane-keeping control system 100 can perform steering torque control by providing steering overlay torque in such a manner that a lane-keeping controlled vehicle can provide a feeling as if it runs on a bath tub-shaped road as shown in FIG. 3 without being moved out of its lane through steering torque maps 251 produced on the basis of a running track 241 deviated in consideration of a neighboring vehicle.

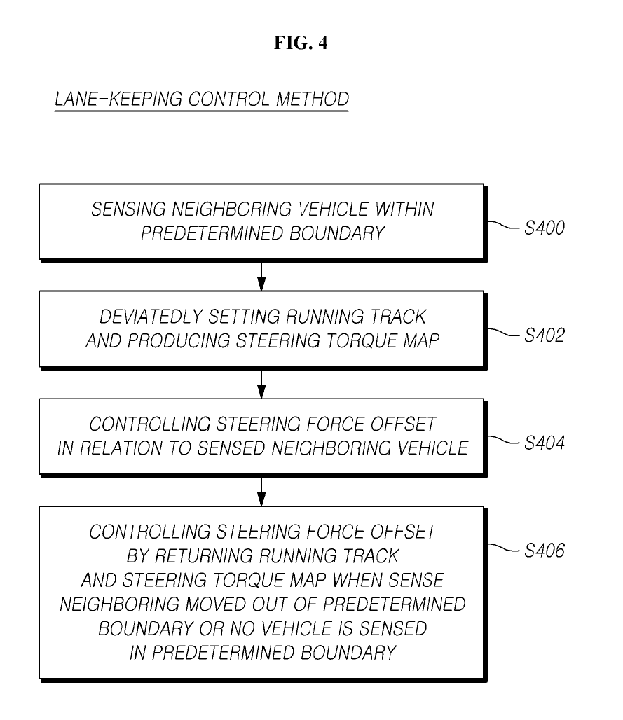

FIG. 4 is a flowchart for a lane-keeping control method in accordance with another embodiment of the present invention.

Referring to FIG. 4, the inventive lane-keeping control method includes the steps of: sensing a neighboring vehicle positioned within a predetermined boundary on the basis of lane information capable of being obtained by analyzing an image of an adjacent area acquired through a camera, and neighboring vehicle information for a neighboring vehicle in a lane adjacent to a lane-keeping controlled vehicle's lane (S400); setting the running track of the lane-keeping controlled vehicle to be deviated from the center of the lane-keeping controlled vehicle's lane in the direction opposite to a neighboring vehicle within the lane-keeping controlled vehicle's lane which the neighboring vehicle is sensed in the predetermined boundary, and producing steering torque maps to be deviated along the running track set to be deviated (S402); making the lane-keeping controlled vehicle keep its lane by controlling steering force offset oriented to the lane-keeping controlled vehicle's lane on the basis of the steering torque maps produced to be deviated (S404); and returning the running track deviatedly set in step S402 to the original state thereof and returning the steering torque maps deviatedly produced in step 402 to the original states thereof along the returned running track, when no neighboring vehicle is sensed within the predetermined boundary or the sensed neighboring vehicle was moved out of the predetermined boundary as the lane-keeping controlled vehicle passed ahead of the sensed neighboring vehicle or the sensed neighboring vehicle passed ahead of the lane-keeping controlled vehicle, and controlling the steering force offset on the basis of the returned steering torque maps in such a manner that the lane-keeping controlled vehicle keeps its lane when no neighboring vehicle exists within the predetermined boundary (S406).

According to the present invention, a driver can be assisted to drive a vehicle safely without causing the vehicle to be moved out of its lane since when the lane-keeping of the vehicle is controlled, considering a neighboring vehicle traffic situation as well as the situation of a neighboring lane.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units. In addition, although each of the components may be implemented as an independent hardware, some or all of the components may be selectively combined with each other, so that they can be implemented as a computer program having one or more program modules for executing some or all of the functions combined in one or more hardwares. Codes and code segments forming the computer program can be easily conceived by an ordinarily skilled person in the technical field of the present invention. Such a computer program may implement the embodiments of the present invention by being stored in a computer readable storage medium, and being read and executed by a computer. A magnetic recording medium, an optical recording medium, a carrier wave medium, or the like may be employed as the storage medium.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. A lane-keeping control system comprising:
an information acquiring device for acquiring lane information for a neighboring lane, and neighboring vehicle information for a neighboring vehicle in a lane neighboring with a lane in which a lane-keeping controlled vehicle is running;
an electronic control device for setting a running track of the lane-keeping controlled vehicle in the lane-keeping controlled vehicle's lane on the basis of the acquired lane information and the neighboring vehicle information, the electronic device producing steering torque maps along the running track, and calculating a steering overlay torque values from the produced steering torque maps; and
a steering device for performing steering torque control in accordance with the steering overlay torque values calculated by the electronic control device.

2. The lane-keeping control system as claimed in claim 1, wherein the information acquiring device senses a lane and a neighboring vehicle through an image of a neighboring area acquired through a camera,
the information acquiring device acquires the lane information which includes at least one of a lateral offset between the lane-keeping controlled vehicle and a sensed lane, a heading angle of the lane-keeping controlled vehicle, and a road's curvature, on the basis of the sensed lane, and
the information acquiring device acquires the neighboring vehicle information which includes at least one of a distance between the sensed neighboring vehicle and the lane-keeping controlled vehicle, the transverse position of the sensed neighboring vehicle, and the speed of the sensed neighboring vehicle, on the basis of the sensed neighboring vehicle.

3. The lane-keeping control system as claimed in claim 1, wherein on the basis of the lane information and the neighboring vehicle information acquired by the information acquiring device, if it is determined that the neighboring vehicle exists in a left or right lane neighboring with the lane-keeping controlled vehicle's lane, the electronic control device sets the running track of the lane-keeping controlled vehicle to be deviated from the center of the lane-keeping controlled vehicle's lane in the direction opposite to the neighboring vehicle, and sets the steering torque maps to be also deviated along the deviatedly set running track.

4. The lane-keeping control system as claimed in claim 3, wherein the electronic control device determines the extent for deviating the lane-keeping controlled vehicle's track on the basis of the transverse position of the neighboring vehicle included in the neighboring vehicle information.

5. The lane-keeping control system as claimed in claim 1, wherein the steering device performs steering torque control by adding the steering overlay torque values to at least one of a steering torque value exerted by a driver and a steering torque value exerted by the steering device.

6. A lane-keeping control method comprising the steps of:
sensing a neighboring vehicle positioned within a predetermined boundary on the basis of lane information, and neighboring vehicle information for a neighboring vehicle existing in a lane neighboring with a lane in which a lane-keeping controlled vehicle is running;
setting a running track of the lane-keeping controlled vehicle to be deviated from the center of the lane-keeping controlled vehicle's lane in the direction opposite to the neighboring vehicle within the lane-keeping controlled vehicle's lane when the neighboring vehicle is sensed in the predetermined boundary, and producing steering torque maps to be deviated along the deviatedly set running track; controlling steering force offset oriented to the lane-keeping controlled vehicle's lane on the basis of the deviatedly produced steering torque maps; and
returning the deviatedly set running track and the deviatedly produced steering torque maps to the original states thereof, respectively, when no neighboring vehicle is sensed within the predetermined boundary or the sensed neighboring vehicle is out of the predetermined boundary, and controlling the steering force offset on the basis of the returned steering torque maps.
